(19) United States
(12) Patent Application Publication
(10) Pub. No.: US 2013/0283300 A1
(43) Pub. Date: Oct. 24, 2013

(54) TRAY LOCKING DEVICE OF OPTICAL DISC DRIVE

(71) Applicants: Cheng-Chung Hsu, Hsinchu (TW); Yung-Han Wu, Hsinchu (TW); Sz-Shian He, Hsinchu (TW); Ming-Chun Tsao, Hsinchu (TW); In-Shuen Lee, Hsinchu (TW)

(72) Inventors: Cheng-Chung Hsu, Hsinchu (TW); Yung-Han Wu, Hsinchu (TW); Sz-Shian He, Hsinchu (TW); Ming-Chun Tsao, Hsinchu (TW); In-Shuen Lee, Hsinchu (TW)

(73) Assignee: LITE-ON IT CORPORATION, TAIPEI CITY (TW)

(21) Appl. No.: 13/551,585

(22) Filed: Jul. 17, 2012

(30) Foreign Application Priority Data
Apr. 20, 2012 (CN) 201210118836.2

(51) Int. Cl. G11B 17/03

(52) U.S. Cl. 720/610; G9B/17.009

(57) ABSTRACT

A tray locking device of an optical disc drive adapted to lock and release a tray is provided. The optical disc drive has an optical head engaged with a lead screw and driven to move by the lead screw. The tray locking device includes a pushing member disposed on the optical head, a latching hook for latching and releasing a pin, and a transmission assembly disposed between the pushing member and the latching hook. The transmission assembly includes first and second lever elements. The first lever element pivoted in the tray has a slide slot having a first protrusion portion therein. The second lever element has a second protrusion portion adapted to move within the slide slot. When the tray is to be ejected, the lead screw drives the pushing member to push the second lever element, such that the second protrusion portion is aligned with the first protrusion portion.

### CROSS-REFERENCE TO RELATED APPLICATION

This application claims the priority benefit of China application serial no. 201210118836.2, filed on Apr. 20, 2012. The entirety of the above-mentioned patent application is hereby incorporated by reference herein and made a part of this specification.

### BACKGROUND OF THE INVENTION

1. Field of the Invention

The present invention relates to a tray locking device and more particularly, to a tray locking device of an optical disc drive.

2. Description of Related Art

As the advanced development of computer technology largely increases, processing a variety of data types is increased and a larger storage capacity is also needed. Optical discs have the advantages of reasonable price, portability, large storage capacity, easy data storage, long storage term, secure storage of data, and so on, so the optical disc has gradually replaced the conventional magnetic storage medium and becomes an indispensable optical storage medium in modern life. With the widespread use of the optical disc, the optical disc drive for reading the data in the optical disc has also become a common electronic product in daily life.

In general, an optical head is disposed within the optical disc drive, and the optical head is driven to move forward and backward via driving members, such as lead screw, so that the optical head can read the optical disc carried on the tray. Besides the above mentioned driving members such as lead screw, some tray locking devices have to be disposed within the optical disc drive so as to fix the tray within the optical disc drive and release the tray when the tray is to be ejected under an ejection command, so that users can easily place or take out the optical disc.

In conventional optical disc drive, electromagnetic plungers or motors are used to control to lock or release the tray. However, a large numbers of components have to be disposed within the optical disc drive and the space thereof is occupied, and it leads to restrict compactness of the optical disc drive and also increases the manufacturing cost.

### SUMMARY OF THE INVENTION

The present invention provides a tray locking device of an optical disc drive, and the tray locking device can save the number of components to be used therein and the internal space of the optical disc drive is also saved. Furthermore, the manufacturing cost can be effectively reduced.

The present invention provides a tray locking device of an optical disc drive adapted to latch and release a tray. The optical disc drive having an optical head engaged with a lead screw and driven to move by the lead screw. The tray locking device includes a pushing member disposed on the optical head, a latching hook for latching and releasing a pin, and a transmission assembly disposed between the pushing member and the latching hook. The transmission assembly includes a first lever element and a second lever element, wherein the first lever element is pivoted in the tray. The first lever element has a slide slot, and the slide slot has a first protrusion portion therein. The second lever element has a second protrusion portion, and the second protrusion portion is adapted to move within the slide slot. When the tray is to be ejected, the lead screw drives the pushing member to push the second lever element, such that the second protrusion portion is aligned with the first protrusion portion.

In order to make the aforementioned and other features and advantages of the invention more comprehensible, embodiments accompanying figures are described in detail below.

### BRIEF DESCRIPTION OF THE DRAWINGS

The accompanying drawings constituting a part of this specification are incorporated herein to provide a further understanding of the invention. Here, the drawings illustrate embodiments of the invention and, together with the description, serve to explain the principles of the invention.

FIG. 1 is a schematic view showing a perspective view of an optical disc drive according to one embodiment of the present invention.

FIG. 2 is a schematic view showing the tray is ejected from the optical disc drive of FIG. 1.

FIG. 3 is a schematic view of the tray locking device of the optical disc drive of FIG. 1.

FIG. 4 is a schematic view showing the first lever element and the second lever element of FIG. 3.

FIG. 5A and FIG. 5B are the operating states of the tray releasing process of the tray locking device of FIG. 3.

FIG. 6 is a schematic view showing the first lever element and the second lever element of FIG. 5A.

FIG. 7A and FIG. 7B are schematic views showing the operating states of the tray locking device of FIG. 3 subjected to an impact.

FIG. 8 is a schematic view showing the first lever element and the second lever element of FIG. 7A.

### DESCRIPTION OF EMBODIMENTS

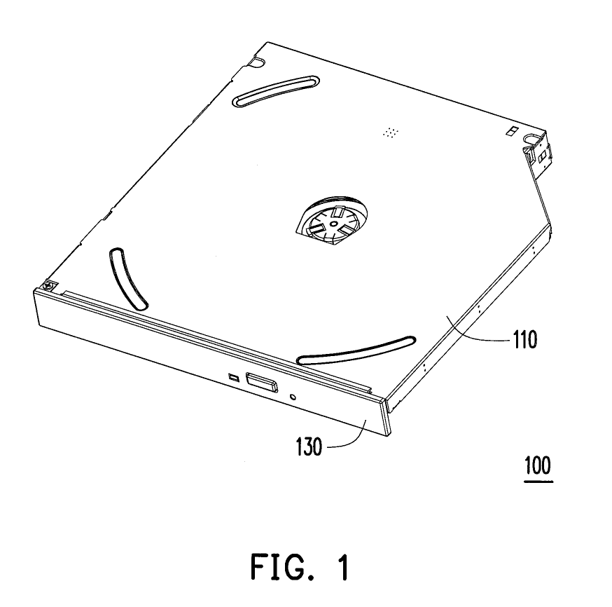

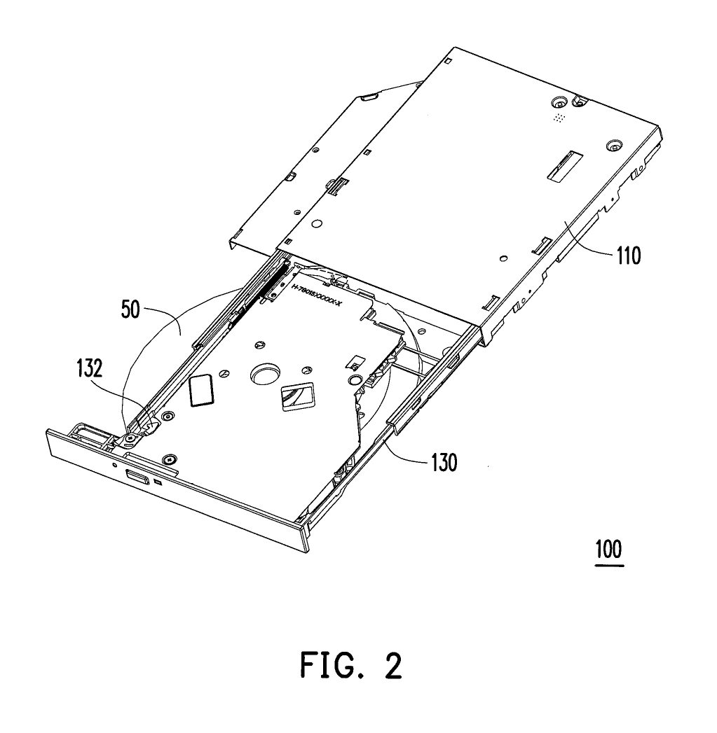

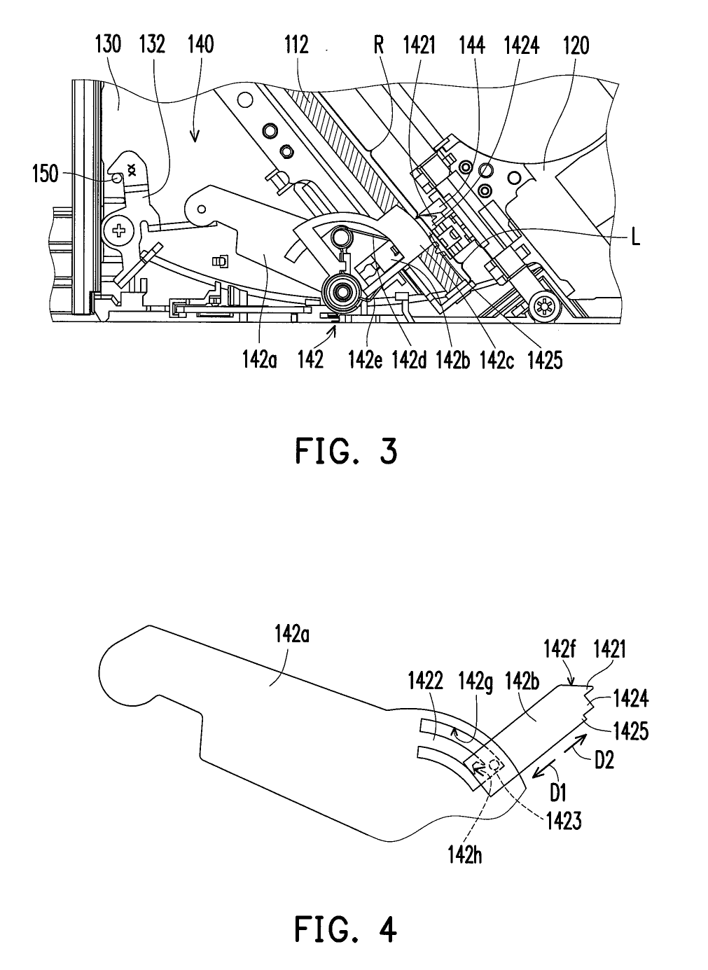

FIG. 1 is a schematic view showing a perspective view of an optical disc drive according to one embodiment of the present invention. FIG. 2 is a schematic view showing the tray is ejected from the optical disc drive of FIG. 1. FIG. 3 is a schematic view of the tray locking device of the optical disc drive of FIG. 1. Referring to FIG. 1 to FIG. 3, the optical disc drive 100 of the present embodiment includes a housing 110, an optical head 120, a tray 130, a lead screw 112 and a tray locking device 140. The optical head 120 is engaged with the lead screw 112. When the lead screw 112 rotates, the lead screw 112 drives the optical head 120 to move along the lead screw 112 relatively. The tray 130 is slidably disposed in the housing 110 and has a locking position (as shown in FIG. 1) and an ejecting position (as shown in FIG. 2).

The tray locking device 140 of the present embodiment includes a transmission assembly 142, a pushing member 144 and a latching hook 132. The latching hook 132 is pivoted in the tray 130 and is configured to latch and release a pin 150 in order to further lock and release the tray 130. The pushing member 144 is disposed on the optical head 120. The pushing member 144 and the optical head 120 can be driven by the lead screw 112 to move. The transmission assembly 142 is disposed between the pushing member 144 and the latching hook 132, wherein the pushing member 144 pushes the transmission assembly 142, such that the transmission assembly 142 drives the latching hook 132 to rotate, so that the latching hook 132 releases the pin 150, and the tray 130 can be ejected from the housing 110.

In the embodiment of the present invention, the tray locking device 140 is disposed on the tray 130, and the pin 150 is disposed on the housing 110, thus when the latching hook 132 of the tray locking device 140 latches the pin 150, the tray 130 is also locked in the housing 110. When the latching hook 132 releases the pin 150, the tray 130 is ejected to the outside of the housing 110.

Referring to FIG. 3 and FIG. 4, wherein FIG. 4 is a schematic view showing the first lever element and the second lever element of the transmission assembly according to one embodiment of the present invention. The transmission assembly 142 includes a first lever element 142a, a second lever element 142b and a rotating member 142c. The first lever element 142a is pivoted in the tray 130, and has a slide slot 142g. The slide slot 142g has a first protrusion portion 1422 therein. The rotating member 142c is pivoted in the tray 130, and the second lever element 142b is slidably disposed on the rotating member 142c. The second lever element 142b has a second protrusion portion 1423 and a driving portion 1421. The second protrusion portion 1423 is adapted to move within the slide slot 142g, and the first protrusion portion 1422 has a notch 142h for containing the second protrusion portion 1423.

The driving portion 1421 has a first step portion 1424 and a second step portion 1425. The first step portion 1424 and the second step portion form a stepped shape. In the present embodiment, the driving portion 1421 further has a guide inclined surface 142f configured to guide the pushing member 144 pushing the second lever element 142b to move so that the pushing member 144 can reach the first step portion 1424.

The driving portion 1421 is disposed on a moving path of the pushing member 114. The driving portion 1421 divides the lead screw 112 into a reading segment R and a loading segment L, wherein the reading segment R is the segment from the driving portion 1421 to an end of the lead screw 112, and the loading segment L is the segment from the driving portion 1421 to another end of the lead screw 112.

When the tray 130 is to be ejected, the lead screw 112 drives the pushing member 144 to move from the reading segment R to the loading segment L, and then the lead screw 112 drives the pushing member 144 to move toward the reading segment R. By doing so, the driving portion 1421 of the transmission assembly 142 can be pushed by the pushing member 144 to actuate the transmission assembly 142 and to drive the latching hook 132 to rotate, so that the latching hook 132 releases the pin 150 so that the tray 130 is ejected from the housing 110.

In the present embodiment, the transmission assembly 142 further includes a plurality of elastic members 142d, 142e for providing the first lever element 142a, the second lever element 142b and the rotating member 142c an elastic force, so that the transmission assembly 142 is back to an initial state, as shown in FIG. 3.

The transmission assembly of the embodiment of the present invention is disposed between the pushing member and the latching hook. The transmission assembly is driven by the pushing member to drive the latching hook to operate. The further illustrations of the releasing process of the tray are shown as follow.

When the optical disc drive 100 is reading an optical disc 50, the lead screw 112 simultaneously drives the optical head 120 and the pushing member 144 to move within the reading segment R. At this time, the tray 130 is locked in the housing 110, namely, the latching hook 132 latches the pin 150, as shown in FIG. 3.

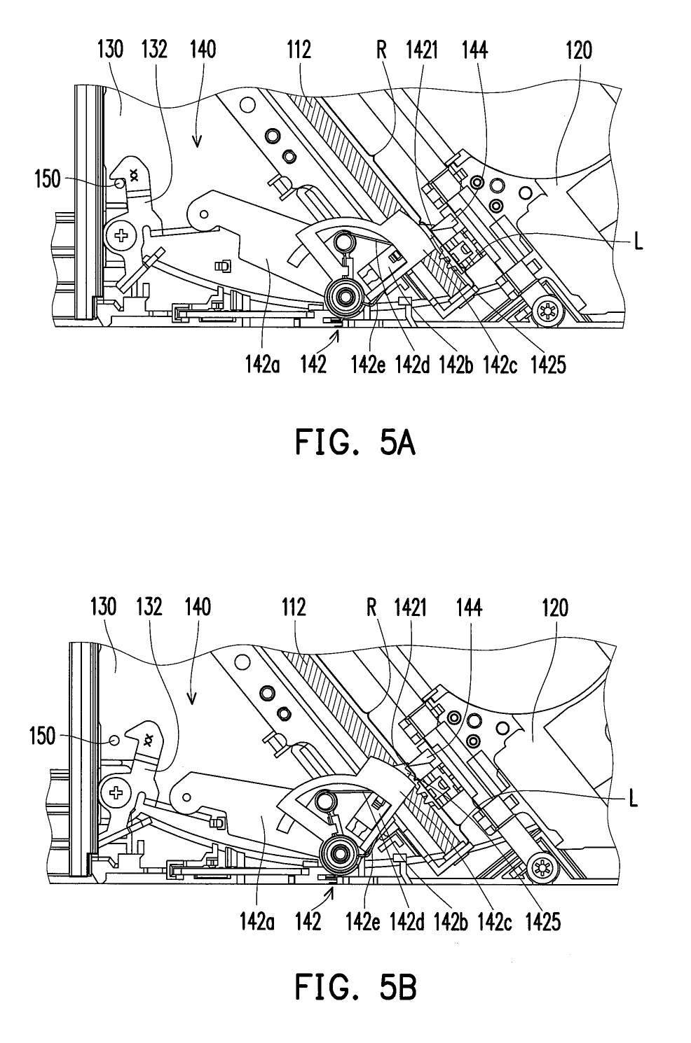

Referring to FIG. 3 and FIG. 4, when the tray 130 is to be ejected from the optical disc drive 100, the lead screw 114 drives the pushing member 144 to move from the reading segment R to the loading segment L, and pushes the second lever element 142b to move along a direction D1, so as to cross over the driving portion 1421 and lean on the first step portion 1421. When the pushing member 144 pushes the second lever element 142b to move along the direction D1, the second lever element 142b is subjected to the elastic force along a direction D2, thus, when the pushing member 144 crosses over the driving portion 1421, the second lever element 142b is subjected to the elastic force and moves along the direction D2, such that the pushing member 144 and the first step portion 1424 are leaned on each other, as shown in FIG. 5A.

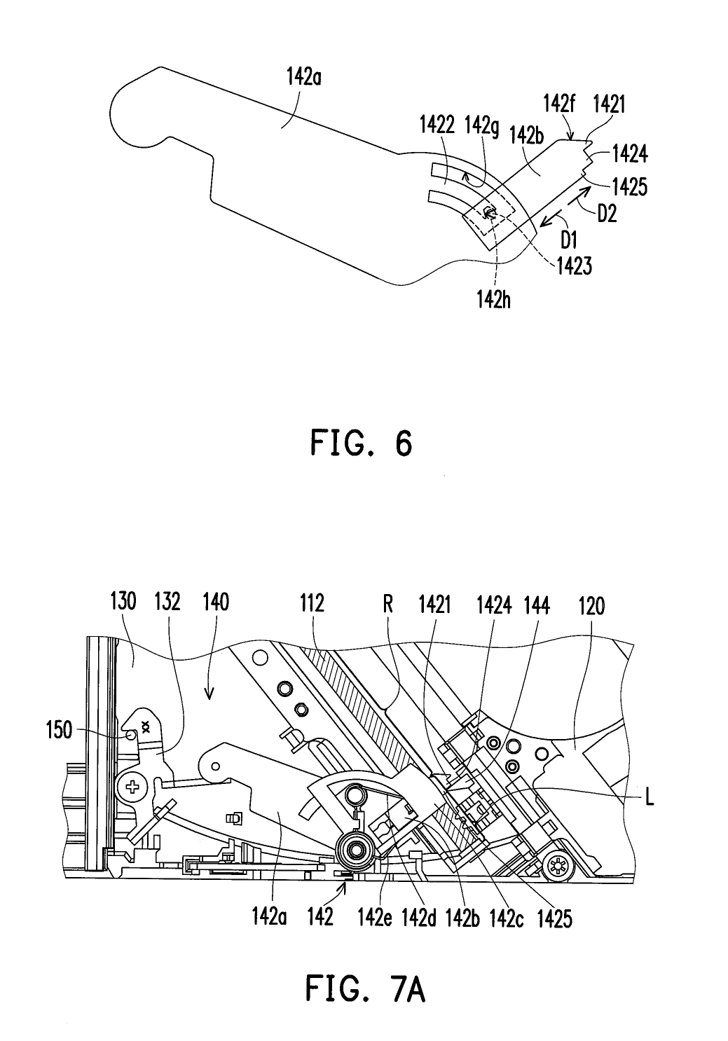

FIG. 5A and FIG. 5B are the operating states of the tray releasing process of the tray locking device of FIG. 3, wherein FIG. 5A is a schematic view showing the pushing member 144 crossing over the driving portion 1421 to enter the loading segment L and leaning on the first step portion 1421. FIG. 6 is a schematic view showing the first lever element and the second lever element of FIG. 5A. When the pushing member 144 leans on the first step portion 1421, the second protrusion portion 1423 of the second lever element 142b is moved to be aligned with the first protrusion portion 1422 of the first lever element 142a.

Next, Referring to FIG. 5B, the pushing member 144 is driven reversely to move toward the reading segment R, and pushes the second lever element 142b and the rotating member 142c to rotate. Meanwhile, the second protrusion portion 1423 enters the notch 142h and pushes the first protrusion portion 1422, so that the first lever element 142a rotates and drives the latching hook 132 to release the pin 150, such that the tray 130 is released and ejected from the housing 110.

According to the tray locking device of the present invention, the lead screw 112 not only can drive the optical head 120 to move to read the optical disc 50, it also can drive the pushing member 144 to push the transmission assembly 142 such that the transmission assembly 142 drives the latching hook 132 to operate so as to release the tray 130 to be ejected from the housing 110. In other words, the existing lead screw 112 of the optical disc drive 100 is used to drive the tray locking device, thus the internal space of the optical disc drive 100 can be saved and the manufacturing cost can be reduced.

Furthermore, when the optical head 120 moves close to the loading segment L, if, meanwhile, the optical disc drive 100 is subjected to an impact, the pushing member 144 is very likely to cross over the driving portion 1421 and enters the loading segment L. At the time, when the optical head 120 is moving back to the reading segment R, the pushing member 144 will push the transmission assembly 142 to operate and accidentally release the tray to be ejected from the housing.

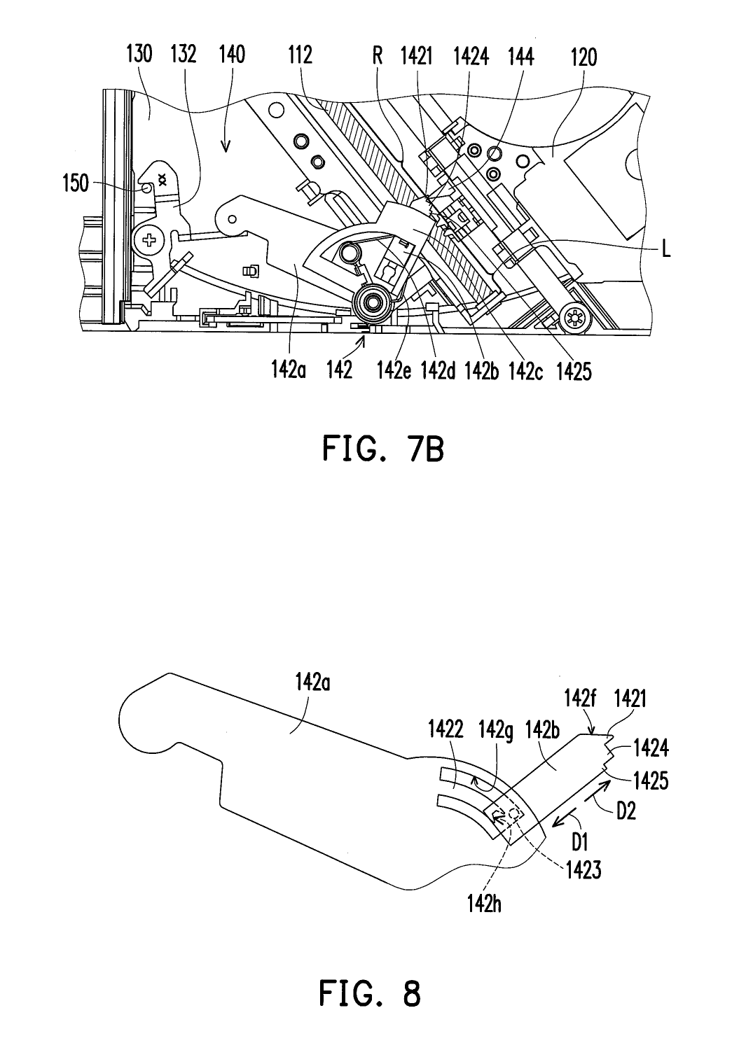

In order to prevent the tray 130 from being released by accident, the present embodiment provides the tray locking device 140 with impact processing mechanism. Refer to FIG. 7A, FIG. 7B and FIG. 8, wherein FIG. 7A and FIG. 7B are schematic views showing the operating states of the tray locking device of FIG. 3 subjected to an impact, and FIG. 8 is a schematic view showing the first lever element and the second lever element of FIG. 7A.

When the optical head 120 moves close to the loading segment L, as shown in FIG. 3, if, meanwhile, the optical disc drive 100 is subjected to an impact which makes the optical head 120 move and enter the loading segment L. Moreover, the pushing member 144 will lean on the second step portion 1425, as shown in FIG. 7A. Furthermore, when the optical disc drive 100 detects the impact, the lead screw 112 forces the optical head 120 and the pushing member 144 to move until the pushing member 144 leans on the second step portion 1425.

Referring to FIG. 8, when the pushing member 144 leans on the second step portion 1425, the first protrusion portion 1422 of the first lever element 142a and the second protrusion portion 1423 of the second lever element 142b are misaligned, in other words, the first protrusion portion 1422 and the second protrusion portion 1423 are interlaced with each other. When the lead screw 112 drives the optical head 120 to move back to the reading segment R, the pushing member 144 pushes the second lever element 142b and the rotating member 142c to rotate. At the time, the second protrusion portion 1423 moves within the slide slot 142g of the first lever element 142a, and is unable to push to first lever element 142a to rotate, as shown in FIG. 7B. Thus, the pushing member 144 accidentally entering the loading segment L to release the tray by accident can be avoided.

In other words, when the pushing member 144 unexpectedly enters the loading segment L due to the external impact, the impact force makes the pushing member 144 cross over the first step portion 1424 of the second lever element 142b and leans on the second step portion 1425, such that the first protrusion portion 1422 and the second protrusion portion 1423 are interlaced with each other. Furthermore, when the optical disc drive 100 detects the impact, the lead screw 112 can be activated and moves the pushing member 144 to the position of the second step portion 1425. By doing so, when the lead screw 112 drives the optical head 120 to move back to the reading segment R, the second lever element 142b is unable to drive the first lever element 142a, so as to prevent the tray 130 from being released accidentally when the optical disc drive 100 is in operation.

In conclusion, the lead screw of the present invention not only can drive the optical head to read the optical disc, but also can drive the tray locking device to release the tray so that the tray can be ejected from the optical disc drive. In other words, the optical head and the tray locking device shares the same lead screw, thus the internal space of the optical disc drive can be saved and the manufacturing cost can be reduced. Furthermore, the tray locking device of the present invention further has impact processing mechanism, with the stepped shape design of the first step portion and the second step portion incorporated with the disposition of the first protrusion portion and the second protrusion portion, so as to prevent the tray from being accidentally released by the tray locking device and being ejected from the optical disc drive.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. A tray locking device of an optical disc drive, adapted to lock and release a tray, the optical disc drive having an optical head engaged with a lead screw and driven to move by the lead screw, the tray locking device comprising:
a pushing member, disposed on the optical head;
a latching hook, adapted to latch and release a pin; and
a transmission assembly, disposed between the pushing member and the latching hook, wherein the transmission assembly comprises a first lever element and a second lever element, the first lever element is pivoted in the tray, the first lever element has a slide slot, the slide slot has a first protrusion portion therein, the second lever element has a second protrusion portion, and the second protrusion portion is adapted to move within the slide slot,
wherein when the tray is to be ejected, the lead screw drives the pushing member to push the second lever element, such that the second protrusion portion is aligned with the first protrusion portion.

2. The tray locking device as claimed in claim 1, wherein when the optical disc drive is subjected to an impact, the lead screw drives the pushing member to push the second lever element, such that the second protrusion portion is misaligned with the first protrusion portion.

3. The tray locking device as claimed in claim 1, wherein the second lever element has a driving portion, the driving portion has a first step portion and a second step portion, and the first step portion and the second step portion form a stepped shape.

4. The tray locking device as claimed in claim 3, wherein when the pushing member leans on the first step portion, the second protrusion portion is aligned with the first protrusion portion, and when the pushing member leans on the second step portion, the second protrusion portion is misaligned with the first protrusion portion.

5. The tray locking device as claimed in claim 1, wherein the transmission assembly further comprises a rotating member, the rotating member is pivoted on the tray and the second lever element is slidably disposed on the rotating member.

6. The tray locking device as claimed in claim 1, wherein the second lever element has a driving portion, the driving portion has a first step portion and a second step portion, and the first step portion and the second step portion form a stepped shape, wherein when the tray is to be ejected, the lead screw drives the pushing member to move till the pushing member leaning on the first step portion, and when the optical disc drive is subjected to an impact, the lead screw drives the pushing member to move till the pushing member leaning on the second step portion.

7. The tray locking device as claimed in claim 1, wherein the second lever element has a driving portion, and the driving portion divides the lead screw into a reading segment and a loading segment, wherein when the tray is to be ejected, the lead screw drives the pushing member to enter the loading segment and pushing the second lever element, such that the second protrusion portion is aligned with the first protrusion portion, and then the lead screw drives the pushing member to move toward the reading segment and pushing the second lever element, such that the second protrusion portion pushes the first protrusion portion so as to drive the first lever element to rotate, and the first lever element drives the latching hook to release the pin.
